(19) United States
(12) Patent Application Publication
(10) Pub. No.: US 2007/0262994 A1
(43) Pub. Date: Nov. 15, 2007

(54) Mechanism for animated load graph analysis of system metrics

(75) Inventors: Sean C. Meighan, Brighton, CO (US); Gabriel M. Bolano, San Ramon, CA (US)

Correspondence Address: SUN MICROSYSTEMS, INC. c/o DORSEY & WHITNEY, LLP, 370 SEVENTEENTH ST., SUITE 4700, DENVER, CO, 80202, US

(73) Assignee: Sun Microsystems, Inc.

(21) Appl. No.: 11/432,884

(22) Filed: May 10, 2006

(51) Int. Cl. G06T 15/70

(52) U.S. Cl. 345/473

(57) ABSTRACT

In one embodiment, a method and apparatus for animated load graph analysis of system metrics is disclosed. The method includes plotting system metric data of components for three dimensions in a two-dimensional graph for a plurality of distinct time periods, wherein a Z-axis of the three dimensions is represented in the two-dimensional graph by colors that each indicate a frequency of an occurrence at an intersection of a X- and a Y-axis of the two-dimensional graph, and animating the two-dimensional graph by portraying the system metric data for the plurality of distinct periods of time in a sequential order beginning with the earliest time period of the distinct periods of time. Other embodiments are also disclosed.

### FIELD OF INVENTION

An embodiment of the invention relates to computer system management, and more specifically, to a mechanism for animated load graph analysis of system metrics.

### BACKGROUND OF INVENTION

Network architectures have many operating components with varying performance levels. These components may produce system metric data that can be monitored to predict and analyze performance of the components. For example, both clients and servers in a network architecture may produce system metric data that can be analyzed. For example, system metric data for a server may include server load. System metric data for a client may be the load profile of the client. Some examples of servers and clients producing measurable system metrics include lightweight direct access protocol (LDAP) servers, Network File System (NFS) servers, web proxy servers, databases, thin clients, or a computer doing central processing unit (CPU) bound calculations, to name a few examples.

Many network architectures separate clients from servers. An instance of such a network architecture is one utilizing a multitude of thin clients connected to one or more central servers that supply the processing capabilities to the thin clients. A thin client has little or no application logic so that it depends primarily on the central server for its processing capabilities. The word “thin” refers to the small boot image which such clients typically require—perhaps no more than required to connect to a network and start up a dedicated web browser or other remote desktop connection.

A problem encountered in network architectures with separated clients and servers, such as one utilizing thin clients, is that it is difficult to manage the variety of components involved in such a network architecture. For example, central servers may provide processing capabilities for many clients in a network. Someone managing this architecture may want to understand and visualize the system metrics taking place in this system, such as the server load experienced by the central servers due to the multitude of clients utilizing these central servers. This information helps to better manage the network architecture for increased performance and reliability.

A way to visualize server or client load as it changes throughout the day would be beneficial. Such a method of visualization may further allow for capacity planning and other management functions on any server or client in a network architecture.

### SUMMARY OF INVENTION

The present invention includes novel methods and apparatus for animated load graph analysis of system metrics.

According to one embodiment of the invention, a method is disclosed. The method includes plotting system metric data of components for three dimensions in a two-dimensional graph for a plurality of distinct time periods, wherein a Z-axis of the three dimensions is represented in the two-dimensional graph by colors that each indicate a frequency of an occurrence at an intersection of a X- and a Y-axis of the two-dimensional graph, and animating the two-dimensional graph by portraying the system metric data for the plurality of distinct periods of time in a sequential order beginning with the earliest time period of the distinct periods of time.

According to another embodiment of the invention, an apparatus is disclosed. The apparatus includes a plurality of components in a network architecture and a central management server in the network architecture communicatively connected to the plurality of components, the central management server to: plot system metric data of components for three dimensions in a two-dimensional graph for a plurality of distinct time periods, wherein a Z-axis of the three dimensions is represented in the two-dimensional graph by colors that each indicate a frequency of an occurrence at an intersection of a X- and a Y-axis of the two-dimensional graph; and animate the two-dimensional graph by portraying the system metric data for the plurality of distinct periods of time in a sequential order beginning with the earliest time period of the distinct periods of time.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

The invention may be best understood by referring to the following description and accompanying drawings that are used to illustrate embodiments of the invention. In the drawings:

FIG. 1 is a block diagram of one embodiment of an exemplary network architecture;

FIG. 2A is a three-dimensional graph according to an embodiment of the invention;

FIG. 2B is a two-dimensional graph according to an embodiment of the invention;

FIGS. 3A through 3E depict a time series of two-dimensional graphs according to one embodiment of the invention;

FIG. 4 is a flow diagram illustrating one embodiment of a method of the invention; and

FIG. 5 is an illustration of an embodiment of a computer system.

### DETAILED DESCRIPTION

A method and apparatus are described for animated load graph analysis of system metrics. According to one embodiment, the method includes plotting system metric data of components for three dimensions in a two-dimensional graph for a plurality of distinct time periods, wherein a Z-axis of the three dimensions is represented in the two-dimensional graph by colors that each indicate a frequency of an occurrence at an intersection of a X- and a Y-axis of the two-dimensional graph, and animating the two-dimensional graph by portraying the system metric data for the plurality of distinct periods of time in a sequential order beginning with the earliest time period of the distinct periods of time.

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions, to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, hard disk, optical disks, CD-ROMs, and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data. Moreover, data discussed herein may be stored in a single database, multiple databases, or otherwise in select forms (such as in a table).

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

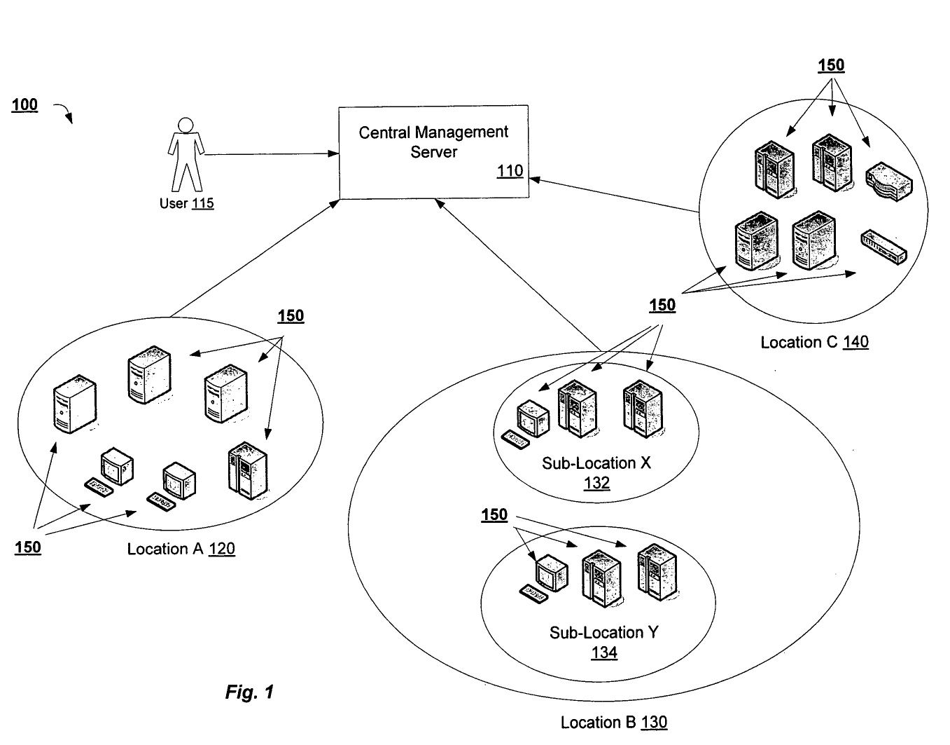

Embodiments of the invention introduce a novel method for animated load graph analysis of system metrics. FIG. 1 is a block diagram illustrating an exemplary network architecture to apply various embodiments of the invention. Network 100 includes central management server 110, location A 120, location B 130, and location C 140.

Each of the locations 120, 130, 140 may include various components 150. These components 150 may be, for example, servers, clients (e.g., thin clients), routers, switches, or other various system components for use in a network architecture. One skilled in the art will appreciate that there are a variety of network components that embodiments of the invention may apply to.

In one embodiment, locations 120, 130, 140 may be dispersed geographic locations. For example, location A 120 may be in Sydney, Australia, location B 130 may be in the United States, and location C 140 may be in London, England. Each location 120-140 may further include one or more sub-locations 132, 134 that are located within the parent location. For instance, location B 130 may include sub-location X 132 and sub-location Y 134. Continuing with our example locations, sub-location X 132 may be Broomfield, Colo. and sub-location Y 134 may be in Santa Clara, Calif., both located within the United States (i.e., location B 130).

Central management server 110 may be used to manage the performance of the various components 150 at each of the locations 120, 130, 140 and sub-locations 132, 134. For example, the central management server 110 may manage multiple thin clients connected to a central server that provided processing power to the thin clients. Central management server 110 may then track performance, provide trend analysis, and offer capacity planning for those servers and thin clients it is monitoring. A user 115 of the central management server 110 may utilize the results from central management server to increase performance and reliability of the network architecture 100.

In one embodiment, central management server 110 may provide its management and tracking services by executing a shell script on the component 150 that is being monitored. This script may provide execution commands that gather system metric data, such as load information and network performance data, from the component 150. In one embodiment, the central management server 110 may utilize software compatible with Linux™, Solaris™, Windows™, or Macintosh™ operating systems.

Output files from the component 150 may then be sent to the central management server 110 for reporting and graphing. By implementing management functions in this way, the central management server 110 does not have to install its processes on every target component 150, and therefore is less resource intensive on the components 150. In some embodiments, an unlimited number of components 150 may be monitored at various time intervals, such as every 30 seconds, every 10 minutes, every hour, etc. This results in a large amount of sampled data for analysis.

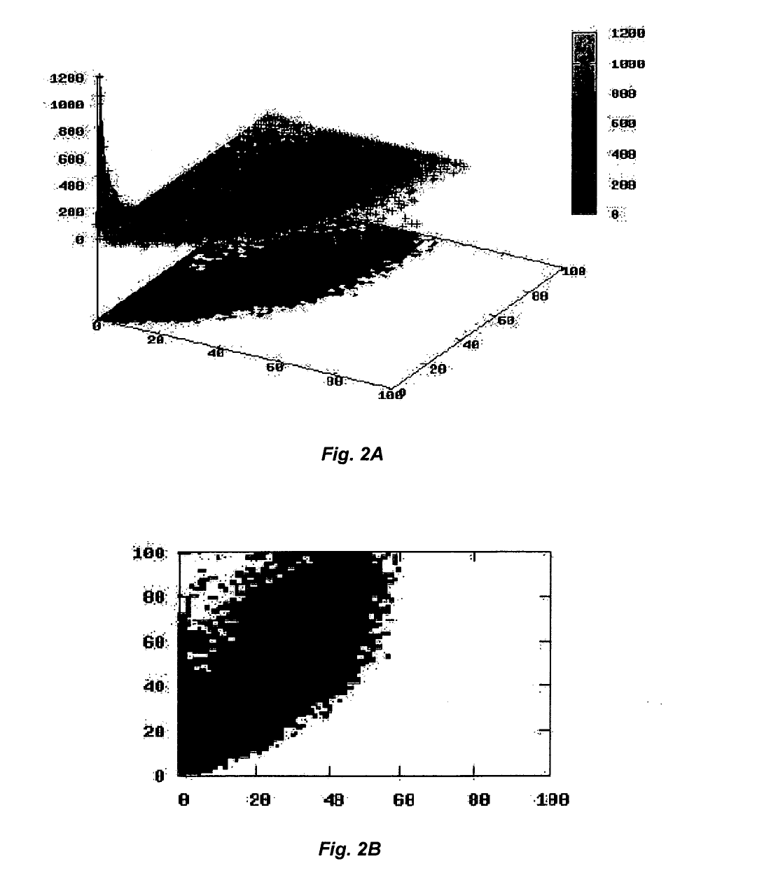

FIG. 2A is a three-dimensional graph illustrating one embodiment of a reporting and analysis function provided by a central management server, such as central management server 110 described with respect to FIG. 1. In one embodiment, system metrics of monitored components are gathered in a graphical report, such as the graph shown here, in order to be analyzed via an animated load graph. Data may be gathered from multiple components, such as servers and clients, according to a specified time interval.

In one embodiment, this data may be summarized so that active users (of the components) displayed on the X-axis may be compared to any number of Y-axis variables. For example, one pertinent Y-axis variable that may be used is server load. The Z-axis may represent the frequency of the particular data sample at an X, Y-axis intersection.

As shown in FIG. 2A, the three-dimensional graph represents one embodiment of the invention where data is collected from multiple servers (e.g., of the same type or at a particular location) at 10 minute intervals for an hour beginning at the noon time period. One skilled in the art will appreciate that embodiments of the invention are not limited to analysis of server metric data and may be applied to a variety of components and types of metric data. In this case, each server supplies data including the number of users utilizing the server on the X-axis and the resulting server load for the particular server on the Y-axis.

Because multiple servers may return identical data for a single X, Y-axis intersection, the Z-axis represents the frequency of data samples collected for that particular X, Y data sample. In some embodiments, all samples from all geographic locations may be summarized, grouping them by server type or by regional area.

In embodiments of the invention, a three-dimensional histogram may then be drawn into a two-dimensional space. FIG. 2B is a graph illustrating such a two-dimensional graph. To maintain the three-dimensional aspect in the two-dimensional graph, color may be utilized on the graph to represent the height of the Z-axis (e.g., frequency of the users). The graph of FIG. 2B is a two-dimensional rendering of the three-dimensional graph of FIG. 2A.

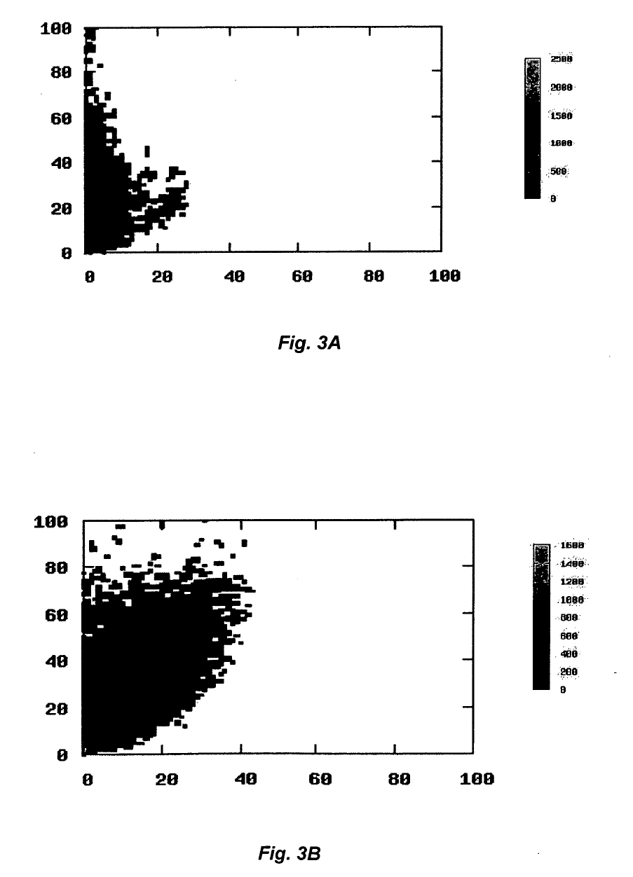

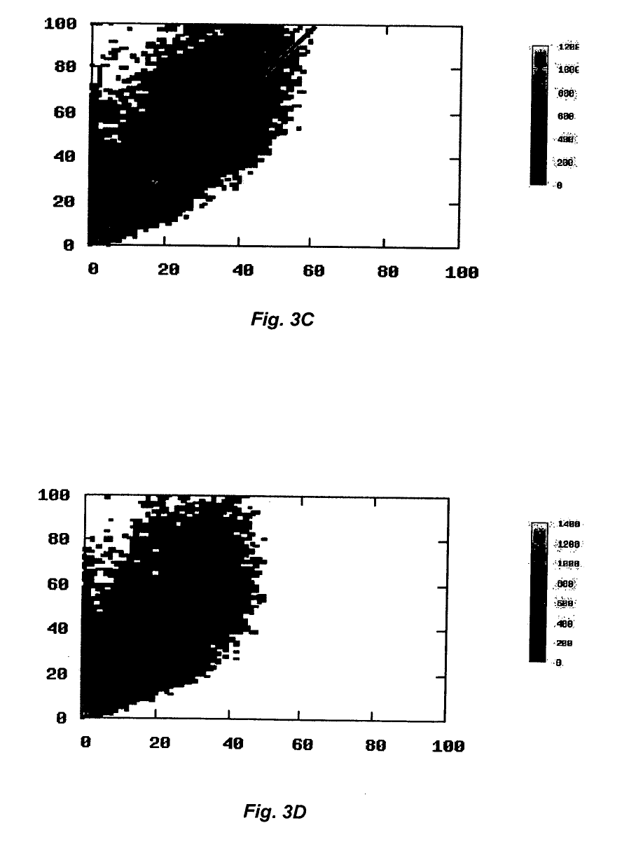

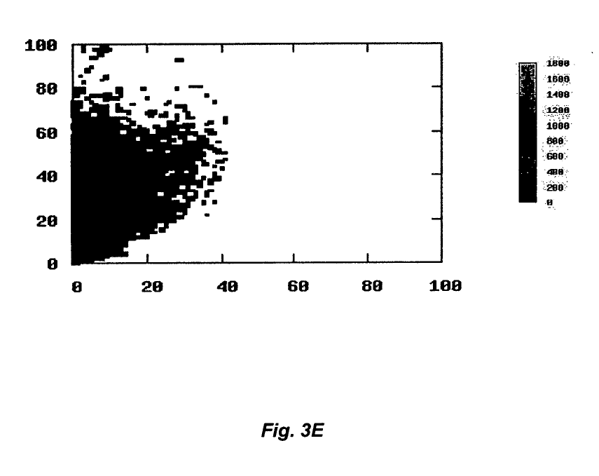

In one embodiment, multiple two-dimensional graphs may be created representing different time periods of data collection. For instance, a graph may be created representing the midnight hour time period. Other graphs may be created representing each hour increment thereafter. FIGS. 3A through 3E are a time-series of two-dimensional graphs illustrating three-dimensions of system metric data, such as that described above with respect to FIG. 2B, throughout a 24-hour time interval of a day.

FIG. 3A illustrates a 12 am (midnight) profile for multiple servers. As shown, the highest frequency of data samples centers around zero users on the server with zero server load on the server. This is indicated by the colors associated with high frequency (i.e., according to the key: yellows, reds, and purples) being centered on the 0, 0 X, Y-axis intersection. Such a sampling is most like accurate as most users are not logged onto their computers at the midnight time period. FIG. 3B illustrates an 8 am profile for the multiple servers. This graph reflects the arrival of users to the various server locations. These users are logging onto the servers and creating load on the servers. The range of data samples, or the “data cloud”, is expanding upward and outward indicating more users and more load on the servers. The higher frequency data samples (indicated by various colors) are centrally located in the data cloud indicating the central areas where most samples are falling.

FIG. 3C illustrates an 11 am profile for the multiple servers. This graph depicts a peak time for users and server load on the servers. Most users have now arrived and are working on the servers. The data cloud in this graph is close to its maximum state as far as users and server load are concerned.

FIG. 3D illustrates a 12 pm (noon) profile for multiple servers. This graph depicts the time period when many users go to lunch, and the resulting number of users and server load on the servers therefore decreases. This can be seen by the collapsed data cloud in the graph as compared to FIG. 3C. FIG. 3E illustrates a 6 pm profile for multiple servers. This graph depicts the time when most users have gone home. The data cloud has collapsed indicating less users and less server load. The data cloud is now approaching the 0, 0 X, Y-axis intersection state for most of the servers.

In one embodiment, the two-dimensional graphs illustrated with respect to FIGS. 3A through 3E may be combined in order to animate the system metrics of components of a network for a determined time period. In one embodiment, multiple graphs representing specified time intervals may be created and animated. The animation may be created by viewing the graphs one after another in a sequential time order. For example, the graphs illustrated with respect to FIGS. 3A through 3E may be utilized, in addition to graphs for the other hour time intervals not provided, to create an animated depiction of the network status. Any suitable software, hardware, or firmware may be utilized to provide the animation of the graphs.

The result of this animation provides a picture that aids in the discovery of (but not limited to): 1) runaway processes; 2) input/output (I/O) bound vs. central processing unit (CPU) bound of a workload; 3) predictors for a component hitting 100% load; and 4) work patterns (e.g., when load arrives, exits, and drops during lunch). The animation visually shows massive amounts of data samples over an extended time period in a few seconds. This allows for management of the components in a network by giving a high-level view of what is happening in the network.

For example, it is possible to view the shapes in the graphs and determine more load-intensive applications versus less load-intensive applications. In some embodiments, the picture provided by the animation aids in rapid capacity planning of a component and the detection of unusual workloads on the component. For example, with respect to FIG. 3C, the graph provides an accurate depiction of the maximum users and server load on the servers. The data cloud in this graph has most likely reached its highest peak and may be used to predict what a server's maximum capacity number of users is. In FIG. 3C, a line is shown illustrating the slope through the data cloud. In one embodiment, this line, in an animated fashion with the other graphs, may be used to determine that sixty users is the maximum number a single server of the type being monitored can handle.

In some embodiments, the animated graphs as described above may be used to compare the performance of component types, such as different servers, or to compare regional performance, such as in different locations or sub-locations. One skilled in the art will appreciate that the animation of the particular two-dimensional graphs described in embodiments of the invention may be utilized for a variety of analysis and monitoring purposes.

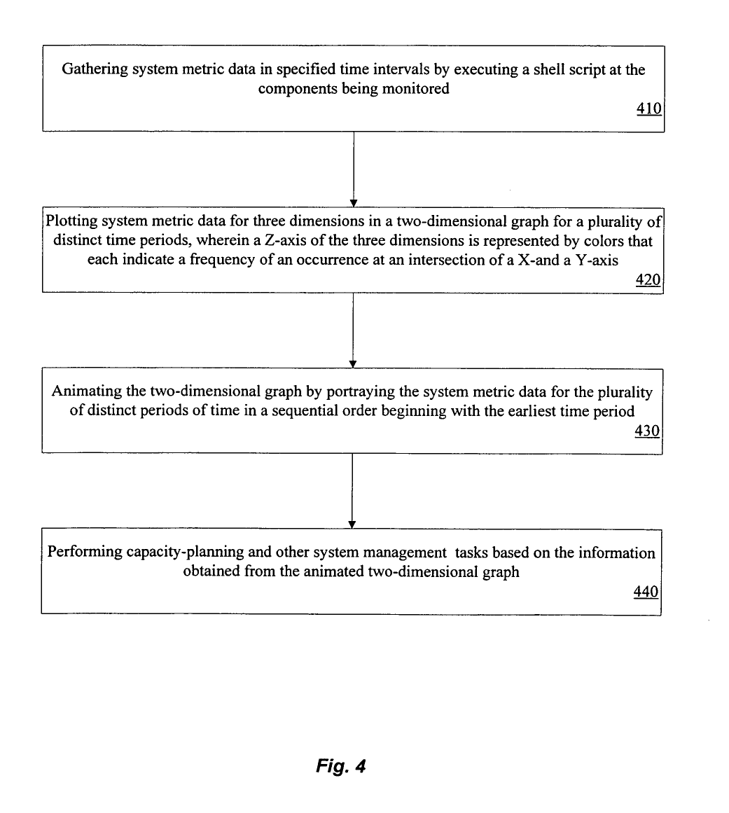

FIG. 4 is a flow diagram depicting a method of one embodiment of the invention. Process 400 is a method to provide animated load graphs for the analysis of system metrics. In one embodiment, the system metric data may be obtained from a network such as that described with respect to FIG. 1. Process 400 begins at processing block 410, where system metric data of a network is gathered in specified time intervals by executing a shell script at components in the network to be monitored. As discussed above with respect to FIG. 1, this shell script causes the monitored components to obtain data and report it back to the central management server.

At processing block 420, this gathered system data is plotted in three dimensions in a two-dimensional graph format for a plurality of distinct time periods. In this two-dimensional graph, the Z-axis of the three dimensions is represented by colors that indicate a frequency of occurrences at each X, Y-axis intersection. The X and Y axis may represent a variety of different system metrics. In one embodiment, the X-axis represents a number of users on a component and the Y-axis represents a load on the component when the particular number of users utilizes the component.

Then, at processing block 430, the two-dimensional graph is animated by portraying multiple two-dimensional graphs for the system metric data at each of the plurality of distinct time periods in a sequential order beginning with the earliest time period that data was obtained. Finally, at processing block 440, capacity planning and other system management tasks are performed by utilizing information obtained from the animated two-dimensional graph.

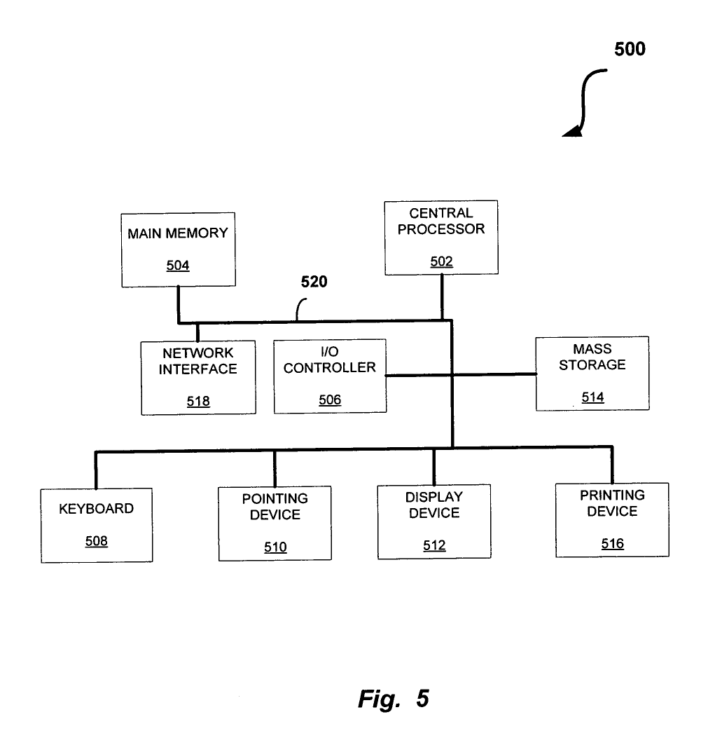

FIG. 5 illustrates an exemplary computer system 500 in which certain embodiments of the present invention may be implemented. In one embodiment, the components of FIG. 1 may be implemented as system 500 or as components of system 500.

System 500 comprises a central processor 502, a main memory 504, an input/output (I/O) controller 506, a keyboard 508, a pointing device 510 (e.g., mouse, track ball, pen device, or the like), a display device 512, a mass storage 514 (e.g., a nonvolatile storage such as a hard disk, an optical drive, and the like), and a network interface 518. Additional input/output devices, such as a printing device 516, may be included in the system 500 as desired. As illustrated, the various components of the system 500 communicate through a system bus 520 or similar architecture.

In a further embodiment, system 500 may be a distributed computing system. In other words, one or more of the various components of the system 500 may be located in a physically separate location than the other components of the system 500. Such components may be accessed and connected via a network to the other components

In accordance with an embodiment of the present invention, the computer system 500 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.).

Also, instead of a single processor, two or more processors (whether on a single chip or on separate chips) can be utilized to provide speedup in operations. It is further envisioned that the processor 502 may be a complex instruction set computer (CISC) microprocessor, a reduced instruction set computing (RISC) microprocessor, a very long instruction word (VLIW) microprocessor, a processor implementing a combination of instruction sets, and the like.

The network interface 518 provides communication capability with other computer systems on a same local network, on a different network connected via modems and the like to the present network, or to other computers across the Internet. In various embodiments of the present invention, the network interface 518 can be implemented utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 500 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments of the present invention, the computer system 500 is a general purpose computer capable of running any number of applications such as those available from companies including Oracle, Siebel, Unisys, Microsoft, and the like.

It should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

The foregoing description has been directed to specific embodiments. It will be apparent to those with ordinary skill in the art that modifications may be made to the described embodiments, with the attainment of all or some of the advantages. Therefore, it is the object of the appended claims to cover all such variations and modifications as come within the spirit and scope of the invention.

What is claimed is:

1. A method comprising:
plotting system metric data of components for three dimensions in a two-dimensional graph for a plurality of distinct time periods, wherein a Z-axis of the three dimensions is represented in the two-dimensional graph by colors that each indicate a frequency of an occurrence at an intersection of a X- and a Y-axis of the two-dimensional graph; and
animating the two-dimensional graph by portraying the system metric data for the plurality of distinct periods of time in a sequential order beginning with the earliest time period of the distinct periods of time.

2. The method of claim 1, further comprising gathering the system metric data in specified time intervals by executing a shell script at the components being monitored.

3. The method of claim 1, further comprising performing capacity planning for the components based on information obtained from the animated two-dimensional graph.

4. The method of claim 3, wherein the information obtained from the animated two-dimensional graph includes the shape and slope of a data cloud in the animated two-dimensional graph.

5. The method of claim 1, wherein the components include one or more servers providing processing capability to one or more clients communicatively connected to the one or more servers over a network.

6. The method of claim 5, wherein an X-axis of the two-dimensional graph represents the number of clients associated with a server of the one or more servers.

7. The method of claim 6, wherein a Y-axis of the two-dimensional graph represents a server load experienced by a server of the one or more servers.

8. The method of claim 1, further comprising determining at least one of runaway processes, input/output bound of a workload, processor bound of a workload, and work patterns for the components based on information obtained from the animated two-dimensional graph.

9. An article of manufacture, comprising a machine-accessible medium including data that, when accessed by a machine, cause the machine to perform operations comprising:
plotting system metric data of components for three dimensions in a two-dimensional graph for a plurality of distinct time periods, wherein a Z-axis of the three dimensions is represented in the two-dimensional graph by colors that each indicate a frequency of an occurrence at an intersection of a X- and a Y-axis of the two-dimensional graph; and
animating the two-dimensional graph by portraying the system metric data for the plurality of distinct periods of time in a sequential order beginning with the earliest time period of the distinct periods of time.

10. The article of manufacture of claim 9, further comprising gathering the system metric data in specified time intervals by executing a shell script at the components being monitored.

11. The article of manufacture of claim 9, further comprising performing capacity planning for the components based on information obtained from the animated two-dimensional graph.

12. The article of manufacture of claim 11, wherein the information obtained from the animated two-dimensional graph includes the shape and slope of a data cloud in the animated two-dimensional graph.

13. The article of manufacture of claim 9, wherein the components include one or more servers providing processing capability to one or more clients communicatively connected to the one or more servers over a network.

14. The article of manufacture of claim 13, wherein an X-axis of the two-dimensional graph represents a number of clients associated with a server of the one or more servers and a Y-axis of the two-dimensional graph represents a server load experienced by a server of the one or more servers.

15. The article of manufacture of claim 9, further comprising determining at least one of runaway processes, input/output bound of a workload, processor bound of a workload, and work patterns for the components based on information obtained from the animated two-dimensional graph.

16. An apparatus, comprising:
a plurality of components in a network architecture; and
a central management server in the network architecture communicatively connected to the plurality of components, the central management server to:
plot system metric data of components for three dimensions in a two-dimensional graph for a plurality of distinct time periods, wherein a Z-axis of the three dimensions is represented in the two-dimensional graph by colors that each indicate a frequency of an occurrence at an intersection of a X- and a Y-axis of the two-dimensional graph; and
animate the two-dimensional graph by portraying the system metric data for the plurality of distinct periods of time in a sequential order beginning with the earliest time period of the distinct periods of time.

17. The apparatus of claim 16, wherein the central management system further to:
gather the system metric data in specified time intervals by executing a shell script at the components being monitored; and
perform capacity planning for the components based on information obtained from the animated two-dimensional graph.

18. The apparatus of claim 16, wherein the components include one or more servers providing processing capability to one or more clients communicatively connected to the one or more servers over a network.

19. The apparatus of claim 18, wherein an X-axis of the two-dimensional graph represents a number of clients associated with a server of the one or more servers and a Y-axis of the two-dimensional graph represents a server load experienced by a server of the one or more servers.

20. The apparatus of claim 16, wherein the central management server further to determine at least one of runaway processes, input/output bound versus processor bound of a workload, and work patterns for the components based on information obtained from the animated two-dimensional graph.
